(19) United States
(12) Patent Application Publication
(10) Pub. No.: US 2010/0057752 A1
(43) Pub. Date: Mar. 4, 2010

(54) DOCUMENT MANAGEMENT APPARATUS, DOCUMENT MANAGEMENT METHOD, AND PROGRAM

(75) Inventor: Koji Kikuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/547,748

(22) Filed: Aug. 26, 2009

(30) Foreign Application Priority Data
Aug. 29, 2008 (JP) 2008-222617

(51) Int. Cl. G06F 17/30

(52) U.S. Cl. 707/10; 707/E17.008

(57) ABSTRACT

A document management apparatus capable of processing a request from a user logged in from an information processing apparatus via a network, includes a user management unit configured to manage attribute information for specifying document information to be used by a user logging in from the information processing apparatus, a document management unit configured to associate document information having different document attributes obtained from the information processing apparatus with one another to manage the document information as integrated document information, a determination unit configured to determine whether the document information requested by the log-in user is an integrated document, a specifying unit configured to specify, when the determination unit determines that the document information requested by the log-in user is an integrated document, document information to be referred to by the user from the integrated document information based on the attribute information by the log-in user, a processing unit configured to process a request from the user for the document information specified by the specifying unit.

### BACKGROUND OF THE INVENTION

1. Field of the Invention

The present invention relates to a document management apparatus for processing user's request logged in from an information processing apparatus.

2. Description of the Related Art

Recent document management realized more efficient sharing/updating of documents by version management that enables revision processing, or check-in/check-out function that exclusively manages update processing of shared documents.

On the other hand, the progress in network technology has widened a range of data sharing: a document management style has changed from information sharing means among members of a division to shared document management which enables access from all over the world via the corporate infrastructure or Internet.

In document management, therefore, a multilanguage function for dealing with a plurality of languages in one server has gained in importance. A processing flow of a general multilanguage function will be illustrated in steps S1 to S3.

In step S1, a user starts an application installed in an information processing apparatus or device, or selects a function provided by the application.

In step S2, the application of the information apparatus or device that has received the user's instruction (simply referred to as “client” hereinafter) issues a display data request to the server. In this case, the request designates the same processing address.

In step S3, to generate display data corresponding to the request, the server makes a request for response processing to a processing address therein (redirect processing).

For example, a multilanguage support technique has conventionally been developed, which returns a desired response to the client by performing the following operation (Japanese Patent Application Laid-Open No. 11-194983).

Client environmental information is transmitted being incorporated in a request. The server side that has received the request automatically switches to a processing address to provide display data prepared beforehand to make a response according to the environmental information of the request side.

Japanese Patent Application Laid-Open NO. 11-194983 discusses a technique which enables switching of screen contents as display data by using the client environmental information.

However, the technique basically concerns the screen display data, and a document (document storing address) itself shown in the screen display cannot automatically be switched to another document according to user's environment. Thus, when a screen display request is made, a screen display content has to be actually generated at each designated processing address to separately set a document of the screen display in each language.

For example, when there are original data of English version and its Japanese translation, the original data of the English version and the Japanese translation have to be respectively set as screen display contents in English screen display data and Japanese screen display data.

If documents are managed without individual setting in different languages, all the documents are embedded, resulting in a complex document list screen list.

If pieces of document information are managed in the form of folders country by country corresponding to languages, folder path management becomes complex. As a result, it becomes difficult to determine association of each document information of the countries to be integrated, with each other.

In addition, version management of document information and checking-in/checking out are carried out in different languages. Thus, a user cannot ascertain to which document information the original data of the English version and its Japanese translation correspond.

Further, a language of the screen display cannot be switched, for example, when the user desires English display while the client of the request side provides Japanese version.

### SUMMARY OF THE INVENTION

The present invention is directed to a system that can execute required processing by specifying document information conforming to a user attribute when a plurality of pieces of document information of different document attributes is managed as an integrated document, and a logging-in user requests the integrated document.

According to an aspect of the present invention, a document management apparatus capable of processing a request from a user logged in from an information processing apparatus via a network, includes a user management unit configured to manage attribute information for specifying document information to be used by a user logging in from the information processing apparatus, a document management unit configured to associate document information having different document attributes obtained from the information processing apparatus with one another to manage the document information as integrated document information, a determination unit configured to determine whether the document information requested by the log-in user is an integrated document, a specifying unit configured to specify, when the determination unit determines that the document information requested by the log-in user is an integrated document, document information to be referred to by the user from the integrated document information based on the attribute information of the log-in user, and a processing unit configured to process a request from the user for the document information specified by the specifying unit.

A document management method in a document management apparatus capable of processing a request from a user logged in from an information processing apparatus via a network, includes managing attribute information for specifying document information to be used by a user logging in from the information processing apparatus, associating document information having different document attributes obtained from the information processing apparatus with one another to manage the document information as integrated document information, determining whether the document information requested by the log-in user is an integrated document, specifying, when the document information requested by the log-in user is determined to be an integrated document, document information to be referred to by the user from the integrated document information based on the attribute information of the log-in user, and processing a request from the user for the specified document information.

According to the exemplary embodiment of the present invention, when plural pieces of document information of different document attributes are managed as an integrated document, and a logging-in user requests the integrated document, required processing can be executed by specifying document information corresponding to a user attribute.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a conceptual diagram illustrating an example of a document management system according to a first exemplary embodiment.

FIG. 2 is a block diagram illustrating a configuration of a server PC and a client PC shown in FIG. 1.

FIG. 3 illustrates a configuration of a multi-function device shown in FIG. 1.

FIG. 4 is a block diagram illustrating a hardware configuration of the complex device shown in FIG. 3.

FIG. 5 illustrates a software configuration of the document management system according to the exemplary embodiment.

FIG. 6 illustrates an example of data processing in a screen display generation unit and an integrated document management unit shown in FIG. 5.

FIG. 7 illustrates an example of data processing in the screen display generation unit and the integrated document management unit shown in FIG. 5.

FIG. 8 illustrates a data processing flow in the document management system according to the exemplary embodiment.

FIG. 9A illustrates an example of a user interface in a data processing system shown in FIG. 1.

FIG. 9B illustrates an example of a user interface in the data processing system shown in FIG. 1.

FIG. 10 is a flowchart illustrating an example of a data processing procedure in a document management apparatus according to the exemplary embodiment.

FIG. 11 illustrate a data processing example in the screen display generation unit and the integrated document management unit shown in FIG. 5.

FIG. 12 illustrates an example of a user interface in the document management apparatus according to the exemplary embodiment.

FIG. 13 is a flowchart illustrating an example of a data processing procedure in the document management apparatus according to the exemplary embodiment.

FIG. 14 illustrates a memory map of a storage medium for storing various data processing programs readable by the document management apparatus according to the exemplary embodiment of the present invention.

### DETAILED DESCRIPTION OF THE EMBODIMENTS

Various exemplary embodiments, features, and aspects of the invention will be described in detail below with reference to the drawings.

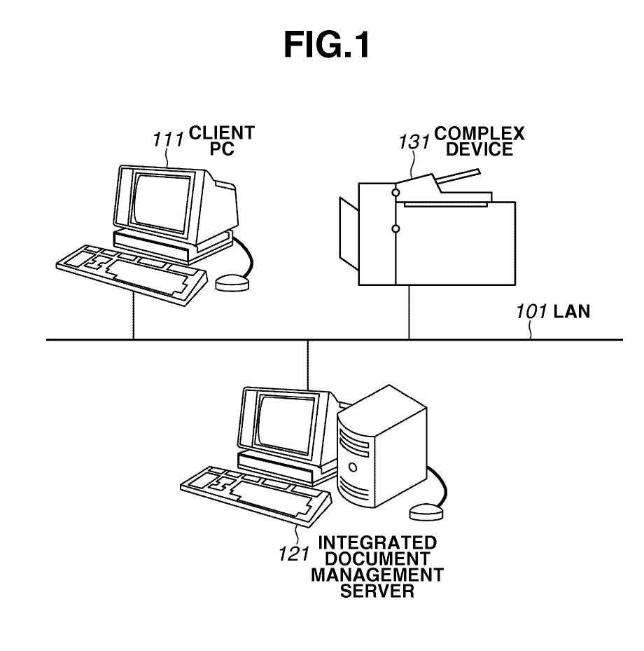

FIG. 1 is a conceptual diagram illustrating an example of a document management system according to a first exemplary embodiment. This example shows a document management system where a server PC serving as a document management apparatus is connected to a client PC and an image forming apparatus serving as an information processing apparatus via a network. A number of the present invention is not limited to the number of client PCs or the image forming apparatus described in the exemplary embodiment. In the exemplary embodiment, the image forming apparatus that is an example of an image processing apparatus includes a multifunction printer (MFP).

In FIG. 1, the document management system includes a local area network (LAN) 101 and a client personal computer (client PC) provided with software resources including hardware resources described below and an operating system (OS).

A server personal computer (server PC) 121 includes software resources provided with hardware resources and an operation system (OS). The server PC 121 performs integrated document management. The server PC 121 and the client PC 111 are interconnected to communicate bi-directionally via the LAN 101.

A complex device 131 includes a UI that can give instructions as a client device of the document management system, and is connected to the LAN 101.

The client PC 111 includes a browser as software resources and is connected to the LAN 101 to give instructions to the server PC 121. In the system, there are no restrictions on a configuration of other components and on a number of connected complex devices and client PCs.

The server PC 121 has an integrated document management system server function. In other words, the server PC 121 receives a display or operation instruction concerning document management from the browser of the client PC 111 and the complex device 131 (two may be generically referred to as “client”).

The server PC 121 returns a result of processing carried out according to a request from the client to the browser of the client that has issued the instruction.

In the exemplary embodiment, there are no restrictions on a communication method (communication protocol) between the server PC 121 and the client.

As in the case of the client PC 111, the complex device 131 includes a browser, and can be connected to the LAN 101 to give instructions to the server PC 121. There are no restrictions on a configuration of other components as long as a printing unit, a scanning unit, and a fax transmission unit that are elements of the complex device are all or partially included.

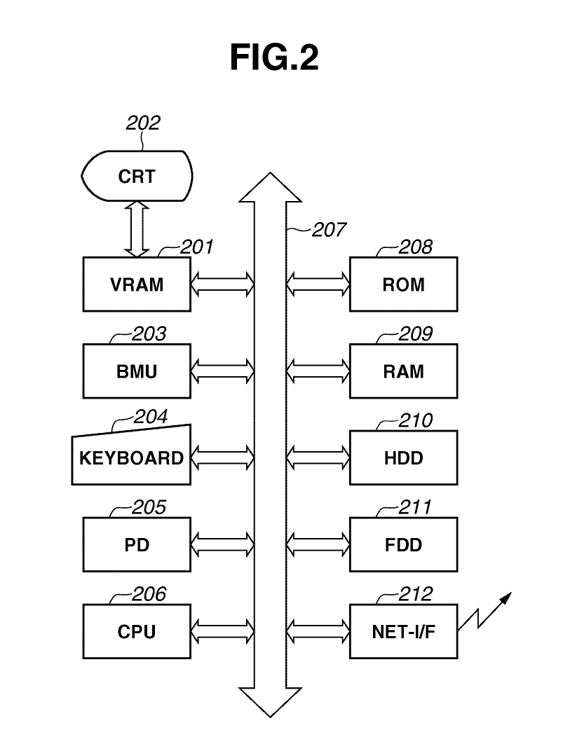

FIG. 2 is a block diagram illustrating a configuration of the server PC 121 and the client PC 111 shown in FIG. 1. Components of hardware resources are almost similar, and thus description will be made by using this drawing.

In FIG. 2, a video RAM (VRAM) 201 expands and stores characters and images to be displayed on a screen of a CRT display apparatus 202.

The CRT display apparatus 202 displays display information obtained from the VRAM 201 on the screen. For example, in the case of the client PC 111, the browser is displayed on this screen. As the display apparatus, a LCD display apparatus may also be used in addition to the CRT display apparatus.

A bit move unit (NMU) 203 controls data transfer between memories or between a memory and a device. A keyboard 204 that functions as an input device includes various keys regarding inputting. A pointing device (PD) 205 manipulates an icon according to an operation from a user to click a button or perform dragging on the screen.

A CPU 206 controls each unit of the apparatus based on a control program stored in a ROM 208. The CPU 206 may load and execute the control program stored in a HDD described below to a RAM 209. The RAM 209 is used as a work area or a temporary saving area during error processing when the CPU 206 executes the program.

A hard disk drive (HDD) 210 functions as an external storage device together with a flexible disk (FD) 211, and is used for storing an application program described below, data, a database or a library.

A network interface (NET-I/F) 212 performs data control and diagnosis on a network to execute data transfer between devices via the network. An I/O bus 207 interconnects the units. The I/O bus 207 includes an address bus, a data bus, and a control bus.

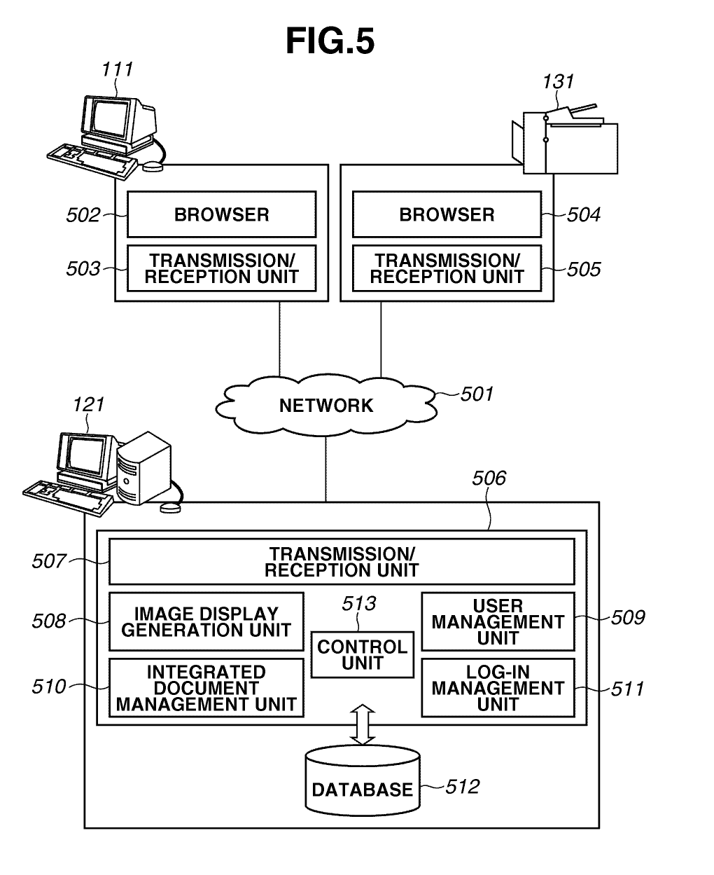

With this configuration, when power is turned ON for the apparatus, the CPU 206 initializes the apparatus according to a boot program of the ROM 208, loads the OS from the HDD 210, and then operates various applications. The applications include software resources shown in FIG. 5.

The document management apparatus of the exemplary embodiment is based on a general personal computer. Programs are accordingly stored in a hard disk. However, the ROM may store programs and an error processing program of the invention and programs described below for realizing the present invention, and the CPU 202 may execute the control program. Thus, a difference in storage media does not affect application of the present invention.

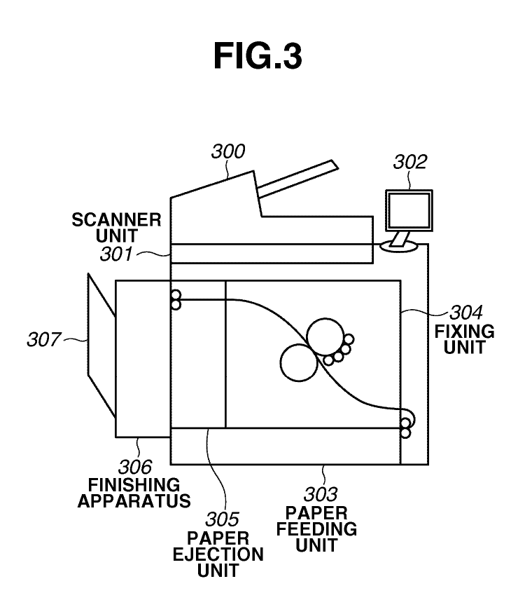

FIG. 3 illustrates a configuration of the complex device 131 shown in FIG. 1. In this case, the complex device 131 is a multifunction printer (MFP).

In FIG. 3, a feeder (automatic document feeder) 300 is a mechanism for automatically feeding paper when scanning is carried out by a scanner unit 301. The document scanner unit 301 scans and computerize paper information. A UI unit 302 displays a browser for giving operation instructions to the server PC 121. The UI unit 302 may include a touch panel.

A paper feeding unit 303 is a mechanism for feeding printed paper to a fixing unit 304 during printing. The fixing unit 304 is a mechanism for fixing toner on the paper fed from the paper feeding unit 303 to execute printing. A paper ejection unit 305 is a mechanism for ejecting the paper printed by the fixing unit 304.

A finishing apparatus 306 is a mechanism for executing processing such as stapling or punching on the paper ejected by the paper ejection unit 305 according to user's instruction. A paper eject tray 307 is a mechanism for lastly holding a printed/finished matter.

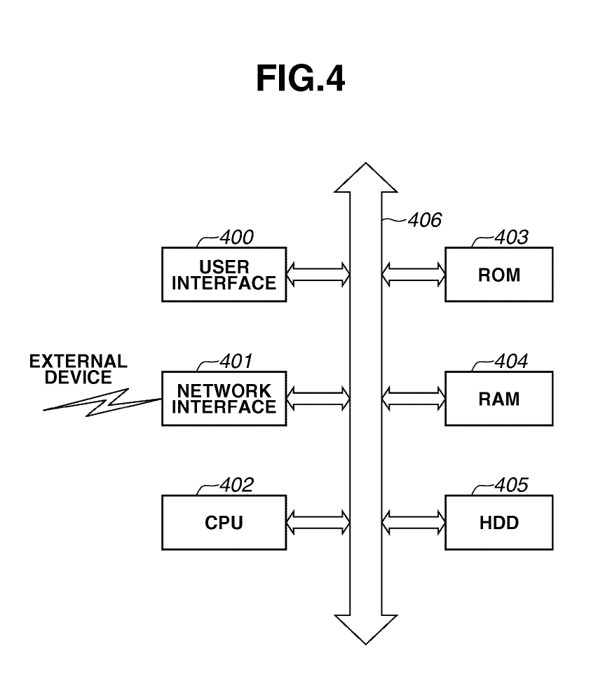

FIG. 4 is a block diagram illustrating a hardware configuration of the complex device 131 shown in FIG. 3. The hardware of the complex device 131 that functions as an information processing apparatus will be described below.

In FIG. 4, a user interface 400 provides various user interfaces to the UI unit 302 operated by the user. The user interface is configured so that the user can directly instruct a user interface displayed on the UI unit 302. A network interface 401 communicates with an external device via a network.

A CPU 402 executes a control program stored in a ROM 403 to control a device connected to an input/output interface 406, thereby controlling the entire complex device. The ROM 403 stores an incorporated program and data. A RAM 404 functions as a work memory area temporarily used by the CPU 402, and is an area for expanding a program during program execution.

A HDD 405 is a large capacity storage area for storing data sent from an external device in the complex device.

FIG. 5 illustrates a software configuration of the document management system according to the exemplary embodiment. In this example of the system, the client PC 111 and the complex device 131 serving as the information processing apparatus are connected to the server PC 121 serving as the document management apparatus via a network 501. The network 501 corresponds to the LAN 101 shown in FIG. 1. There are no restrictions on a type of network protocol.

In the client PC 111 shown in FIG. 5, a browser 502 is an application operated on the client PC 111. The browser 502 displays a result of communication with the server PC 121 to prompt the user to give an instruction via the user interface. When the user gives an operation instruction, a displayed action to the user interface is transmitted to the server PC 121 via a transmission/reception unit 503.

The browser 502 displays a response received by the transmission/reception unit 503 from the server PC 121.

In the complex device shown in FIG. 5, a browser 504 is an application operated on the complex device 131. As in the case of the browser 502, the browser 504 displays a result of communication with the document management server PC 121 to prompt the user to give instructions via a transmission/reception unit 505. The transmission/reception unit 505 transmits/receives information between the browser 503 and the server PC 121.

In the server PC 121 shown in FIG. 5, the CPU 206 loads each processing unit in a server application to the RAM 209 according to a request from the client PC to execute processing. A configuration of each processing unit (functioning as an application) of the server application 506 will be described below.

In the server application 506, a transmission/reception unit 507 receives request information from the transmission/reception unit 503 and 505 of the client PC 111 and the complex device 131 to pass it to a control unit 513. Then, the transmission/reception unit 507 receives a result of processing performed in each processing unit from the control unit 513 to lastly return it as a response to the client PC 111 or the complex device 131 of a request source.

When a request received from the transmission/reception unit 507 is screen display data generation, a screen display generation unit 508 generates, upon reception of an instruction from the control unit 513, screen display data to be displayed on the browsers 502 and 504. The screen display data to be generated may be still HTML data or moving screen display data such as Java (registered trademark) server pages (JSP). The screen display data is generated according to an instruction from the control unit 513.

A user management unit 509 performs user management for the integrated document management system. In the exemplary embodiment, a data structure having user attributes to specify classification attributes in integrated document management is used. The data structure will be described below in detail.

An integrated document management unit 510 performs version management of documents managed on a database 512 or check-in/check-out processing. Folders are prepared for a plurality of documents according to user attributes, and the folders are bundled to realize an integrated document. A data structure will be described below in detail.

When a client instruction to obtain or operate a document is received from the transmission/reception unit 507, the integrated document management unit 510 makes determination to specify a target document based on a classification attribute of an instructing user which is logged in from a log-in management unit 511. The integrated document management unit 510 provides the target document to the instructing user or operates the document.

The log-in management unit 511 performs authentication processing for log-in requests from the browsers 502 and 504 of the client PC 111 and the complex device 131 by using the user management unit 509. The log-in management unit 511 manages user information being logged-in for the authenticated user. The log-in management unit 511 provides attribute information in response to an attribute request that a user has made from the integrated document management unit 510.

The database 512 manages applications for managing data and storage destinations of data.

More specifically, the database 512 manages a storage destinations of each screen data of the screen display generation unit 508, user information of the user management unit 509, and document management information of the integrated document management unit 510. The storage destination of data is the HDD 210, the FDD 211 or the RAM 209 in the server PC 121. The database 512 updates or provides information stored in the HDD 210, the FDD 211 or the RAM 209 according to a request. The control unit 513 controls communications with the processing units.

The document management system of the exemplary embodiment includes the hardware resources for the devices, and executes corresponding applications to control management and presentation of document information corresponding to a language for each user described below.

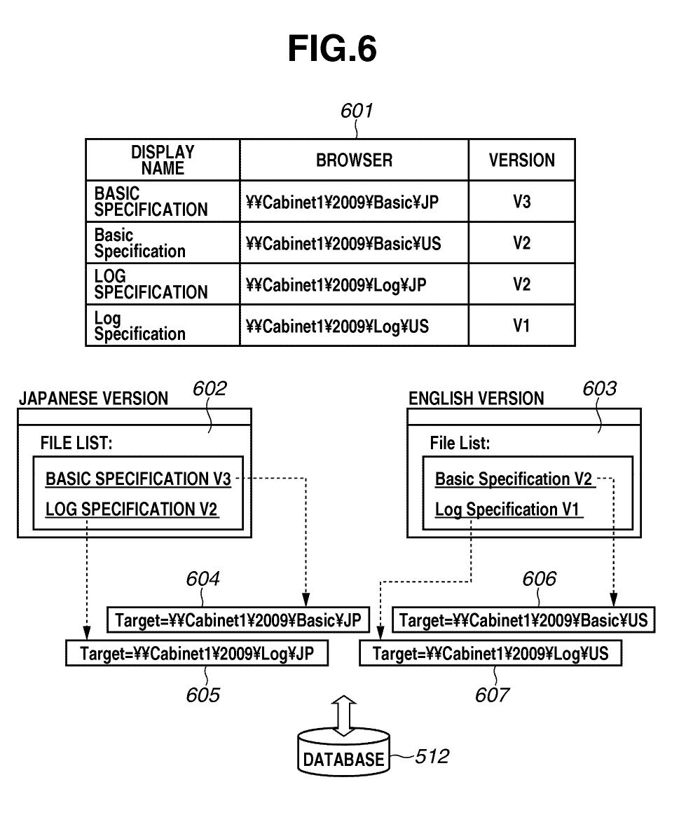

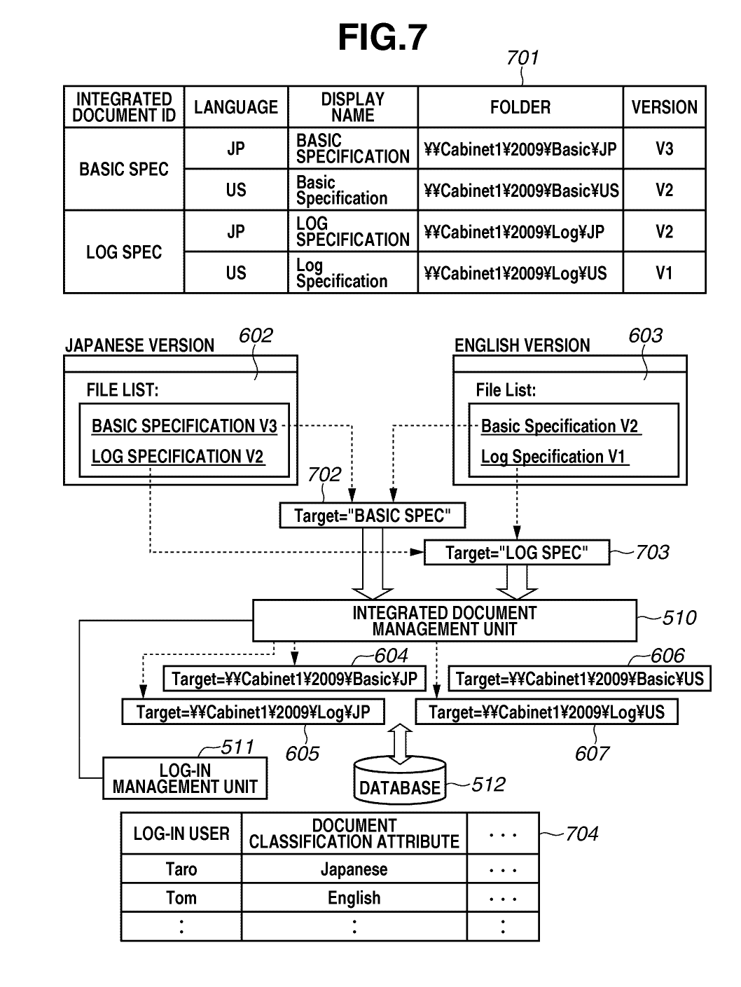

FIGS. 6 and 7 illustrate data processing examples between the screen display generation unit 508 and the integrated document management unit 510 shown in FIG. 5. Hereinafter, switching processing of screen display data carried out by the screen display generation unit 508 and document management processing carried out by the integrated document management unit 510 in the server PC 121 will be described in comparison with a conventional example. FIG. 6 corresponds to a conventional document management example, and FIG. 7 illustrates an example of managing document information for each version according to the exemplary embodiment.

In FIG. 6, a table 601 shows a conventional data list. A display name of a Japanese equivalent of “BASIC SPECIFICATION” is a document stored in a folder “¥¥Cabinet1¥2009¥Basic¥JP”, indicating that a version V3 is latest.

Similarly, a display name “BASIC SPECIFICATION” is a document of a version V2 stored in a folder “¥¥Cabinet1¥2009¥Basic¥US”. A display name of a Japanese equivalent of “LOG SPECIFICATION” is a document of a version V2 stored in a folder “¥¥Cabinet1¥2009¥Log¥JP”, and a display name “LOG SPECIFICATION” is a document of a version V1 stored in a folder “¥¥Cabinet1¥2009¥Log¥US”.

Next, display switching of screen display data will be described.

A screen display 602 indicates a screen display when a language is Japanese. The screen display data is data containing a Japanese equivalent of “FILE LIST”.

A display screen 603 indicates a display when a language is English”. The screen display data is data captaining English “FILE LIST”.

Conventionally, these data have been switched by the same URL according to an environment of a request source client.

In the screen display 602, “BASIC SPECIFICATION” and “LOG SPECIFICATION” are displayed to constitute a document list in Japanese screen display data.

In the screen display 603, two documents of “BASIC SPECIFICATION” and “LOG SPECIFICATION” are listed in English screen display data.

These documents are independent of one another. Instructions to the documents from the screen displays 602 and 603 are accordingly different from each other. Each of commands 604 to 607 represents switching of target documents.

The command 604 is an example of a command to specify a Japanese equivalent of “BASIC SPECIFICATION” of a target document, for example, represented by “Target=¥¥Cabinet1¥2009¥Basic¥JP”. A actual operation is performed by using this command portion and setting an instruction URL to which processing for each document and a server address are lastly added.

For example, http://www.xxx.co.jp/doc mgt?command=updated&Target=¥¥Cabin et¥2009¥Basic¥JP may be employed.

Similarly, the command 605 corresponds to “Target=¥¥Cabinet1¥2009¥Log¥JP” that is a specific command of a Japanese equivalent of “LOG SPECIFICATION”. The command 606 corresponds to “Target=¥¥Cabinet1¥2009¥Basic¥US” that is a specification command of “BASIC SPECIFICATION”. The command 606 corresponds to “Target=¥¥Cabinet1¥2009¥Log¥JP” that is a specific command of “LOG SPECIFICATION”. The commands 604 to 607 specify target documents. These commands enable access to a real database.

In the conventional document management system thus configured, documents different from each other in language, for example, a Japanese equivalent of “BASIC CONFIGURATION” and English “BASIC SPECIFICATION”, in which contents are similar are managed as different documents (similarly in the case of a Japanese equivalent of “LOG SPECIFICATION” and “LOG SPECIFICATION”).

For example, when users who use different languages but wish to share documents of similar contents, a target document cannot be transmitted to the other user.

In other words, when a user of an English environment sends a specific command of “Target=¥¥Cabinet1¥2009¥Basic¥US” by mail to refer to “BASIC SPECIFICATION”, a user of a Japanese environment has no referring method.

Therefore, according to the exemplary embodiment, documents are separated by languages by using commands to specify documents as shown in FIG. 7.

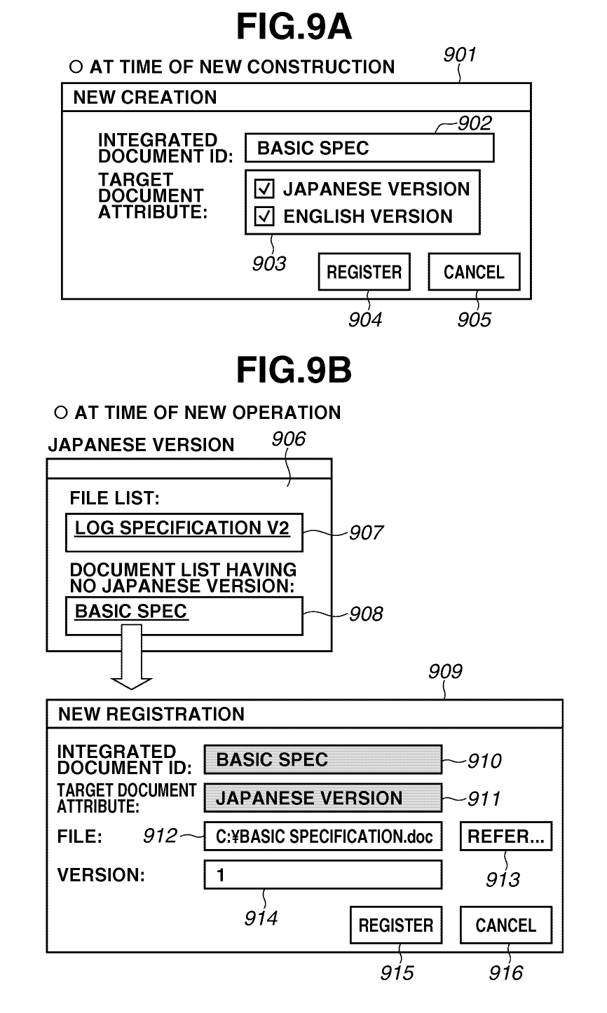

In FIG. 7, a table 701 shows a data list of the exemplary embodiment, where the Japanese equivalent of “BASIC SPECIFICATION” and “BASIC SPECIFICATION” shown in the table 601 are managed as one piece of integrated document information. In other words, the Japanese equivalent of “BASIC SPECIFICATION” and “BASIC SPECIFICATION” are managed for each version (version information) in a mutually associated state. This way, as shown by a command example 702, a command can be represented by “target=BASIC SPEC” that is the same document specifying command regardless whether a language environment is English or Japanese. Thereafter, the user who logs in the server PC 121 can check a document file list provided by the server PC 121 as shown in FIG. 9B. Thus, the user can select document information from the displayed file list and request the integrated document management unit 510 to process the document information.

Similarly, the Japanese equivalent of “LOG SPECIFICATION” and “LOG SPECIFICATION” shown in the table 601 can be represented by integrated document ID “LOG SPEC”, and by “target=”LOG SPEC”” as in the case of a document specifying command 703.

The integrated document management unit 510 specifies an actual target document based on each document specifying command and log-in user information managed by the log-in management unit 511.

For example, when “target=”BASIC SPEC”” of the document specifying command 702 is instructed, the integrated document management unit 510 obtains log-in user information of a request user from the log-in management unit 511 to automatically determine that a real integrated document of which document classification attribute is a target.

When a document classification attribute of the log-in user is a Japanese environment, the integrated document management unit 510 automatically selects “Target=¥¥Cabinet1¥2009¥Basic¥JP” of the specific command 604 to enable a document operation for the Japanese equivalent of “BASIC SPECIFICATION”.

When a document classification attribute of the log-in user is an English environment, the integrated document management unit 510 automatically selects “Target=¥¥Cabinet1¥2009¥Basic¥US” of the specific command 606, thereby setting “BASIC SPECIFICATION” as an operation target document.

The log-in management unit 511 manages, for example, log-in user information shown in a table 704.

As shown in the table 704, “TARO” among users who have logged in has a document classification attribute of “Japanese”, and “TOM” has a document classification attribute of “English”. Thus, the integrated document management unit 510 employs the specific command 604 of a real document with respect to “Target=“BASIC SPEC”” of the document specifying command 702 if a user is “TARO”.

If a user is “TOM”, the integrated document management unit 510 performs processing to employ the specific command 605. By managing a document classification attribute for each user, the log-in management unit 511 can determine which document the integrated document management unit 510 should specify for an integrated document instruction.

Thus, according to the exemplary embodiment, the integrated document management unit 510 enables sharing of the same specific command in different language environments, realizing an operation of documents of identical contents.

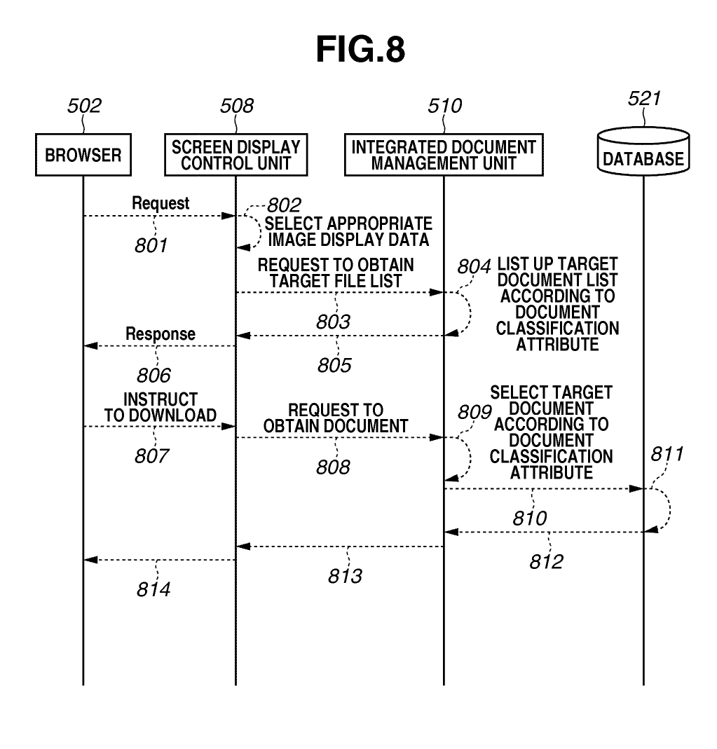

Next, referring to FIG. 8, a sequence of downloading files regarding the screen display of the file list and the files shown in FIG. 7 will be described.

FIG. 8 illustrates a data processing flow in the document management system according to the exemplary embodiment. Components similar to those of FIG. 5 are denoted by similar reference numerals. Now, data processing among the browser 502 of the client PC 111 and the screen display control unit 508, the integrated document management unit 510 and the database 512 of the server PC 121 side will be described. Steps 801 to 806 correspond to a series of operations to display a file list on a screen.

In FIG. 8, first, the browser 502 of the client PC 111 receives an input from the user. In step 801, the browser 502 transmits a request to the control unit 513 of the server PC 121. In actual communication processing, transmission/reception units 503 and 507 on both sides and the network 501 are present. However, they are omitted in the description here.

In step 802, the screen display control unit 508 selects, at the request received from the browser 502 of the client PC 111, screen display data or creates screen display data by a unit of page. The page means a page that can be displayed by, for example, HTML. In step 802, screen display data is prepared to embed a list obtained in step 805.

In step 803, the screen display control unit 508 makes a request for a target file list to be displayed in the selected screen display data, to the integrated document management unit 510. In step 804, the integrated document management unit 510 requests the log-in management unit 511 and obtains, from log-in user information of a request source user, document classification attributes of the table 704, and makes a list of target document information. In this case, the document information is a list represented by integrated document ID.

In step 805, the integrated document management unit 510 returns the list of target document information created in step 804 as a response to the browser 502 of the client PC 111. The screen display control unit 508 embeds the list of target document information obtained from the integrated document management unit 510 in the screen display data prepared in step 802.

In step 806, the screen display control unit 508 returns the generated screen display data and the list of target document information as responses to the browser 502 of the client PC 111.

Steps 801 to 806 are an actual processing flow of screen displaying performed upon reception of a screen display instruction from the user by the browser 502 of the client PC 111.

Next, a series of downloading operations performed by the browser 502 of the client PC 111 that has displayed the file list on a screen in step 806 upon reception of user's instruction will be described.

First, the browser 502 of the client PC 111 waits for a user's instruction of a file to be downloaded from the server PC 121.

In step 807, the browser 502 of the client PC 111 detects a file instructed by user's operation, and instructs the screen display control unit 508 of the server PC 121 to download the data.

In step 808, the screen display control unit 508 of the server PC 121 that has received the downloading instruction from the browser 502 of the client PC 111 requests the integrated document management unit 510 to obtain a document based on integrated document ID.

In step 809, the integrated document management unit 510 makes an inquiry to the log-in management unit 511 to obtain a document classification attribute from the log-in user information of the request source user designated by the screen display control unit 508, and specifies a real document corresponding to the document classification attribute among documents corresponding to the integrated document ID. Thus, by specifying a language desired by the user, a real document of a corresponding language is specified among the documents managed based on the integrated document.

In step 810, the integrated document management unit 510 makes a document obtaining request to the database 512 by using the specified integrated document ID. In step 811, the database 512 prepares documents to enable downloading of the real document requested in step 810. More specifically, the database 512 of the server PC 121 prepares downloading, for example, by reading a real document managed on the HDD 210.

In step 812, information of the real document to be downloaded that has been prepared by the database 512 is returned to the integrated document management unit 510.

In step 813, the information of the real document to be downloaded that has been obtained by the integrated document management unit 510 in step 812 is returned to the screen display control unit 508. In step 814, the screen display control unit 508 transfers the real document obtained from the integrated document management unit 510 to the browser 502 of the client PC 111 that has made the downloading request. As a result, when the user “TARO” designates BASIC SPEC to log in the server PC 121, “¥¥Cabinet1¥2009¥¥Basic¥JP” is displayed as a real document on the screen.

The series of operations in steps 807 to 814 enables downloading of a file from the server PC 121 to the client PC 111.

A feature of the present exemplary embodiment is that an identifier of the document requested in step 807 is integrated document ID, and a real document is specified in step 809.

The series of operations in steps 810 to 814 is not limited to any particular processing as long as normal downloading processing is carried out for a real document.

In the present exemplary embodiment, the example of directly downloading data is described in step 814. However, the screen display control unit 508 may further display a downloading screen having an address of a real document embedded in a link.

Next, referring to FIG. 9A, a construction example of integrated document data in the data processing system according to the exemplary embodiment will be described.

FIG. 9A illustrates an example of a user interface in the data processing system shown in FIG. 1. This example is a screen example for constructing new integrated document data. The construction processing example of integrated document data will be described below.

Each control in a window 901 will be described below.

In FIG. 9A, a text input 902 is a control for inputting integrated document ID that is an identifier of an integrated document. In other words, the text input 902 controls the user to designate integrated document ID during new construction of the document data.

A control 903 is used to designate a document attribute targeted by the integrated document. In the example, since English and Japanese versions are both checked, the integrated document integrates both versions.

In the example, there are two choices. In the case of a plurality of choices, by selecting integration languages, untargeted languages can be excluded.

In the user interface 901, when a pressing event of a register button 904 is received, the browser 502 determines contents of the controls 902 and 903 to instruct the server PC 121 to register the contents with a new integrated document.

In the user interface, when a pressing event of a cancel button 905 is received, the browser 502 discards the contents set in the controls to finish construction of a new folder in the server PC 121.

Thus, management information for new integrated document data is constructed in the server PC 121 by operating the group of controls in the window 901 by the user of the client PC 111.

The management information constructed in this case corresponds to the portions of the integrated document ID and the language of the table 701 shown in FIG. 7. As a result, “BASIC SPEC” is set in the integrated document ID, and “JP” and “US” are set in the language.

The integrated document data that has been already constructed can be corrected by using the window 901. The correction can be made from the server PC 121 or the client PC 111.

FIG. 9B illustrates an example of a user interface in the data processing system shown in FIG. 1. A processing example where the user of the client PC 111 uploads a real document in the integrated document constructed in FIG. 9B will be described below. A window 906 shown in this case is an example when the integrated document “BASIC SPEC” created by using the window 901 is represented in a Japanese environment.

In FIG. 9B, since a Japanese version “LOG SPECIFICATION” has been already selected for the constructed integrated document “LOG SPEC”, a control 907 displays a file list. A version of the log specification is currently V2.

A control 908 is used to display a document list having no Japanese version: the integrated document “BASIC SPEC” registered in the window 901 is displayed. “BASIC SPEC” in the control 908 is clicked based on an instruction from the user, thereby displaying a window 909.

In the example, for the sake of simplicity, a click instruction is a file update instruction. However, each operation instruction may be displayed as a menu, and a menu may be selected by right clicking.

The window 909 is used to register the Japanese version of the integrated document “BASIC SPEC” in the server PC 121. A control 910 is used to display integrated document ID registered in the server PC 121, and to determine an integrated document to be registered. Thus in this case, editing is inhibited.

A control 911 is used to display a target document attribute. A document operation is in a Japanese environment, and Japanese language is determined. Thus, the editing is inhibited.

A control 913 is used to designate a file which is registered this time as a Japanese version of the integrated document. In the example, a local file present in a user environment of “C:¥BASIC SPECICATION.doc” is designated.

The control 913 shows a button to load a control for supporting the file destination of the control 912. This control may be a commonly-used file reference control, and thus is not limited to any specific one in the present invention.

A control 914 is used to designate a document version for a file to be registered this time. A conventional management method may be used for a version of each document, and thus is not limited to any specific method in the present invention.

A register button 915 is pressed by the user to give an instruction to execute registration processing. A cancel button 916 is pressed by the user to give an instruction to cancel the execution of the registration processing. When the user presses the register button 915 to give an instruction, the server PC 121 receives an instructed event. The server PC 121 executes the registration processing to register a file as a Japanese version of the integrated document “BASIC SPEC”.

Regarding the file operations listed in the control 907 of the window 906, general UI representation of file operations may be employed since there has been already a document, and the file operation is not limited to any specific one.

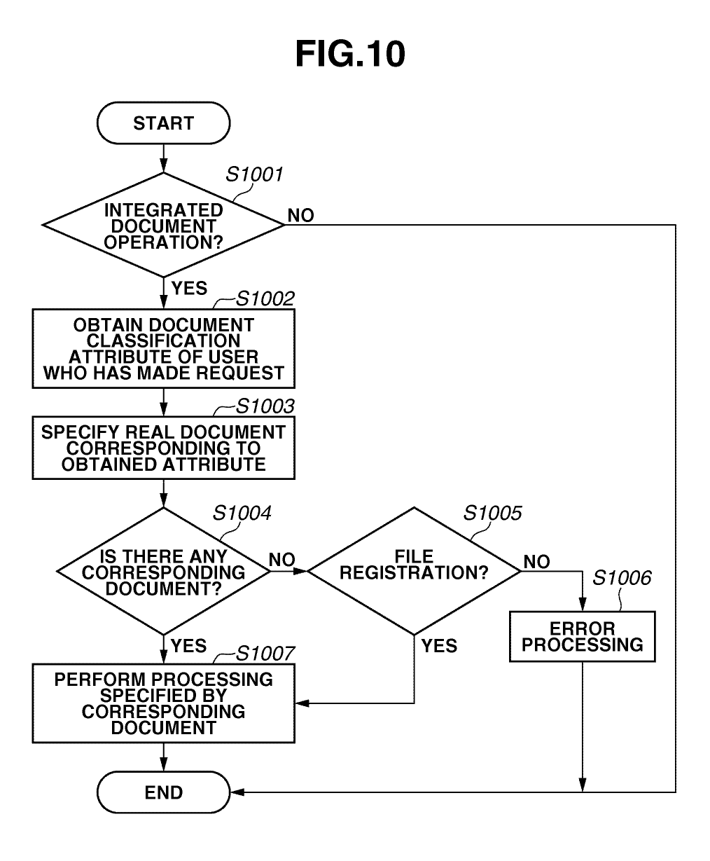

Next, referring to FIG. 10, an operation from an integrated document to a real document will be described in detail.

FIG. 10 is a flowchart illustrating an example of a data processing procedure in the document management apparatus according to the exemplary embodiment. In the example processing, a real document is specified from a designated integrated document by the integrated document management unit 510 and the log-in management unit 511 of the server PC 121 shown in FIG. 5. More specifically, in the processing, the transmission/reception unit 507 of the server PC 121 passes a request received from each client to the control unit 513, and the control unit 513 makes an inquiry to the integrated document management unit 510. Steps S1001 to S1007 are realized by loading a control program to the RAM 209, which the CPU 206 of the server PC 121 executes. The substance of the control program corresponds to the integrated document management unit 510 and the log-in management unit 511 shown in FIG. 5. The control program is stored in a storage medium such as the ROM 208, the HDD 210 or the FDD 211, and loaded to the RAM 209 by the CPU 206 under control of the OS. Thus, in the present exemplary embodiment, functions of an application constitute the integrated document management unit 510 and the log-in management unit 511.

Similarly, the database 512 shown in FIG. 5 is a database application for storing each data, and loaded to the RAM 209 to be executed by the CPU 206 under control of the OS. The database for storing files is constructed in a nonvolatile storage medium such as the HDD 210.

The transmission/reception unit 507 and the control unit 513 are executed as functions of the application 506 by the CPU 206, and data is stored in the RAM 209 for communication.

First, in step S1001, the integrated document management unit 510 determines whether an operation target document in a request of the client PC 111 passed from the control unit 513 is an integrated document. More specifically, the integrated document management unit 510 makes determination based on a content of the control 902. If the integrated document management unit 510 determines that the document is not an integrated document (NO in step S1001) but the document is a real document, the processing of the flowchart is finished to execute conventional processing.

If the integrated document management unit 510 determines that the document is an integrated document (YES in step S1001), the integrated document management unit 510 proceeds to step S1002.

In step S1002, the integrated document management unit 510 obtains corresponding user attribute information from the log-in management unit 511 based on log-in user information about the user of the request passed from the control unit 513. In this case, the log-in management unit 513 holds current log-in user information in the RAM 209, and returns the user attribute information based on the requested log-in user information. In the example of FIG. 7, the user attribute information is a document classification attribute “JAPANESE” when a log-in user is “TARO”.

In step S1003, the integrated document management unit 510 specifies a corresponding real document by using the document classification attribute that is the obtained user attribute information. More specifically, for example, as in the case of the window 906 shown in FIG. 9B, an integrated document is “Target=“LOG SPEC””, and there is a target real document “LOG SPECIFICATION” in a Japanese environment.

On the other hand, in the case of an integrated document “Target=“BASIC SPEC”” and in a Japanese environment, since there is no target real document while a container has been prepared from the control 908, a document list “BASIC SPEC” can be checked.

In step S1004, the integrated document management unit 510 determines whether there is a corresponding real document on the database. If the integrated document management unit 510 determines that there is a corresponding real document (YES in step S1004), the integrated document management unit 510 proceeds to step S1007.

If the integrated document management unit 510 determines that there is no corresponding real document (NO in step S1004) (in which only an integrated document has been registered but a real document is yet to be registered), the process proceeds to step S1005.

While it is determined in step S1004 that there is no corresponding real document, in step S1005, the integrated document management unit 510 determines whether the request is an instruction to register a new real document (corresponding to a registration request to register a document). If the integrated document management unit 510 determines that the request is an instruction to register a new real document (YES in step S1005), registration processing can be executed. Thus, the integrated document management unit 510 proceeds to step S1007 as in the case of determination in step S1004 that there is a real document.

Upon determination that there is no real document but the request is an instruction based on presence of a real document (No in step S1005), the integrated document management unit 510 proceeds to step S1006. In step S1006, since processing execution is inhibited, error processing is carried out to finish the process. In this case, the screen display generation unit 508 generates a corresponding error message and set the message in screen data. The transmission/reception unit 506 notifies the browser 502 of the client PC 111 of the screen data having the set error message to display the data.

In step S1007, processing instructed from step S1004 or S1005, and designated for a corresponding document is carried out. The processing may be similar to a conventional document management function. For example, a request for document information may be a registration request, an updating or editing request, or a downloading request (presentation request) of the document information, however, is not limited to any specific requests in the present invention.

The exemplary embodiment can realize an integrated document management system that can switch a target document based on an integrated document independently of switching of screen display according to information accompanying a user.

The first exemplary embodiment is directed to the case where one document classification attribute is set to log-in user information as shown in FIG. 7. However, depending on a user, for example, an authorized user such as a system administrator (“ADMINISTRATOR”), a plurality of document classification attributes may be set. In addition to the system administrator, users for whom a plurality of document classification attributes is set, include those concerning a relevant document. This is because if a system is world wide operated and projected, not only documents dealing with one language but also those dealing with a plurality of languages have to be processed. Therefore, a second exemplary embodiment where a plurality of document classification attributes is set to a log-in user will be described below. A configuration of hardware resources is similar to that of the first exemplary embodiment, and thus description thereof will be omitted.

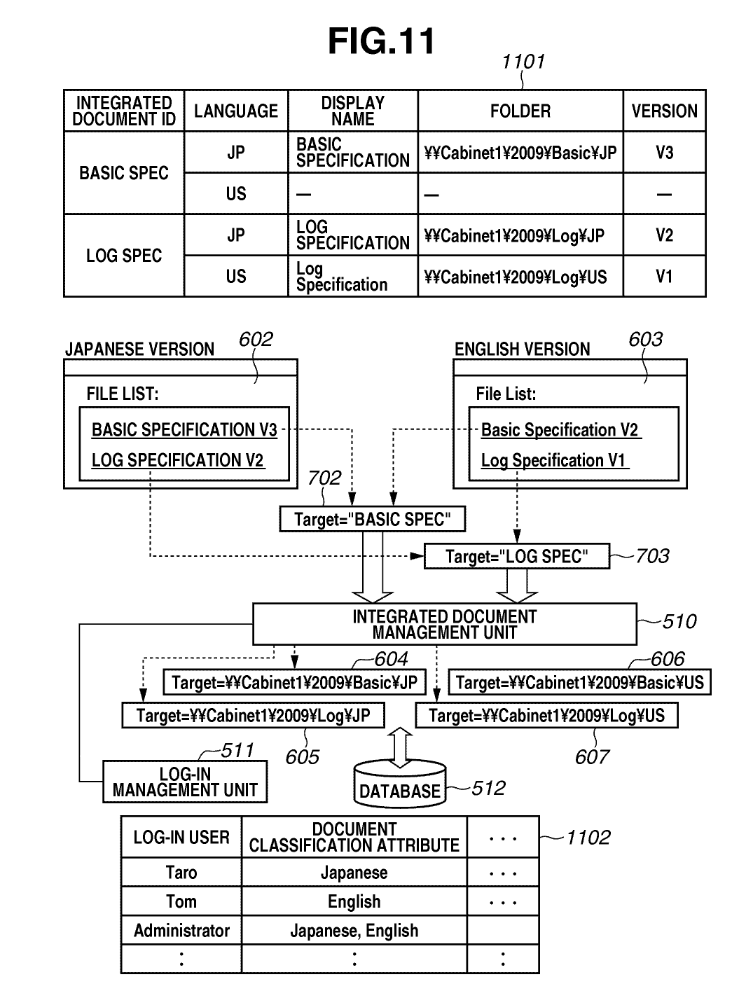

FIG. 11 illustrates a flow dealing with a plurality of languages.

FIG. 11 illustrates an example of data processing in the screen display generation unit 508 and the integrated document management unit 510 shown in FIG. 5. Differences from those in FIG. 7 will be described below.

In a table 1101 shown in FIG. 11, an integrated document indicated by integrated document ID “BASIC SPEC” has only a Japanese version of “BASIC SPECIFICATION”, while there is currently no corresponding document for an English version.

In a table 1102, a log-in user “ADMINISTRATOR” has document classification attributes of both “JAPANESE” and “ENGLISH”.

This setting can be realized by enabling setting of a plurality of document classification attributes in user attribute setting. In this setting, a conventional method can be used and therefore, the method is not limited to any specific one in the present invention.

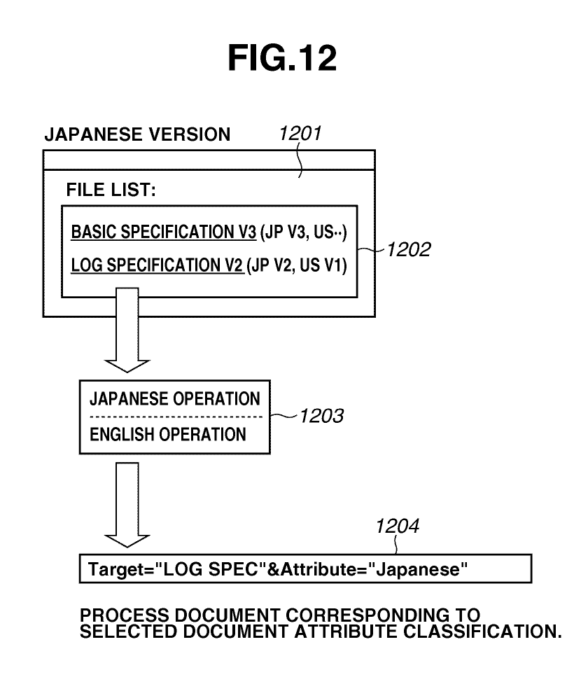

Next, concerning the case of FIG. 11 where the plurality of document classification attributes is set to the integrated document and the user, a display example of UI for separately using the document classification attributes will be described referring to FIG. 12.

FIG. 12 illustrates an example of a user interface in the document management apparatus according to the exemplary embodiment. This screen is displayed in the display apparatus of the server PC 121 shown in FIG. 1.

A window 120 is a display example when a user has document classification attributes of both “JAPANESE” and “ENGLISH” as in the case of the “ADMINISTRATOR” shown in FIG. 11. In this case, as a screen display language, a Japanese environment is selected as an example. As to screen display data, no reference is made in the exemplary embodiment as in the case of the first exemplary embodiment.

In FIG. 12, a control 1202 is an example of file list display in the exemplary embodiment. In the conventional configuration, Japanese and English versions of basic specification and log specification are independent documents, and there are four documents when all are displayed. In the present exemplary embodiment, only two versions are present. In an actual operation, however, many files are present, so that it becomes a complex procedure to determine which documents include similar contents.

In this example, however, Japanese versions up to V3 are already present in the case of “(JP V3, US--)” beside a document name in a Japanese display of “BASIC SPECIFICATION”. It indicates that no English version is present (US--).

Similarly, “LOG SPECIFICATION” indicates that there are latest documents of a Japanese version V2 and an English version V1.

Since integrated documents are displayed in a collective manner, complex document list display in a case of the conventional method can be improved. In the conventional method, all documents are managed in units of folders of real documents, and accordingly displayed separately. In the exemplary embodiment, however, the documents are displayed as an integrated document list. An operation UI 1203 will be described below.

The operation UI 1203 is a control for selecting a document classification attribute that becomes a target this time, for example, when the log specification in the control 1202 is clicked by user's operation. In this example, since an operation “JAPANESE OPERATION” for a Japanese version and an operation “ENGLISH OPERATION” for an English version is displayed, the user can select the operations for Japanese and English versions.

The operation UI 1203 that has received a result of the selection from the user provides integrated document ID and the selected document classification attribute to the integrated document management unit 510. A command example 1204 shows that integrated document ID is “LOG SPEC” and a document classification attribute is “JAPANESE”.

The integrated document management unit 510 specifies a target document by using the integrated document ID and the document classification attribute that have been provided to process a real document.

The display and instruction in the drawing are only examples. Thus, there are no restrictions on them as long as a UI can integrally display integrated documents for each document classification attribute and can allow the user to select a document classification attribute.

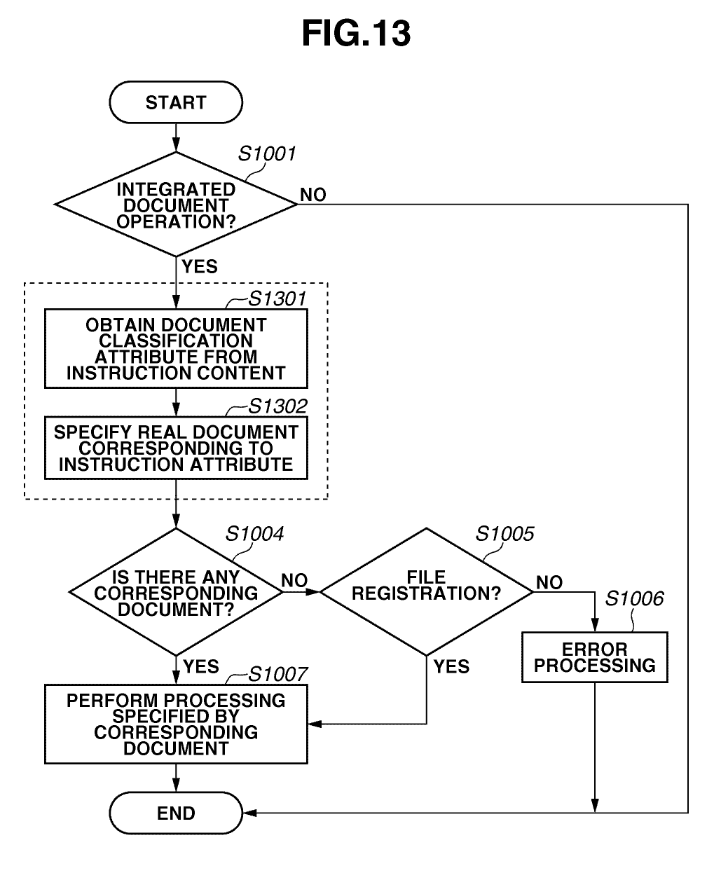

FIG. 13 is a flowchart illustrating an example of a data processing procedure in the document management apparatus of the exemplary embodiment. This processing deals with a corresponding real document based on integrated document ID and a document classification attribute that have been indicated. The CPU 206 of the server PC 121 realizes each of steps S1004 to 1007, S1301 and S1302 by loading a control program to the RAM 209 and executing the program. An entity of the control program corresponds to the integrated document management unit 510 and the log-in management unit 511 shown in FIG. 5. The control program is stored in a storage medium such as the ROM 208, the HDD 210 or the FDD 211, and the CPU 206 loads the control program to the RAM 209 under control of the OS. Thus, the integrated document management unit 510 and the log-in management unit 511 constitute functions of an application.

Similarly, the database 512 shown in FIG. 5 is a data base application for storing each data. The CPU 206 loads the database 512 to the RAM 209 for execution under control of the OS. A database for storing files is constructed in a nonvolatile storage medium such as the HDD 210. A difference of the exemplary embodiment from the first is that step S1002 of FIG. 10 is replaced by step S1301 and step S1003 is replaced by step S1302.

Steps different from those of the flowchart of FIG. 10 will be described below.

Upon determination that an operation is an integrated document operation (YES in step S1001), in step S1301, the integrated document management unit 510 receives a command 1204 shown in FIG. 12. In this command, for example, a document classification attribute is “Attribute=”Japanese””.

Thus, the integrated document management unit 511 obtains a document classification attribute by extracting a target document classification attribute from the received document classification attribute command 1204. In the first exemplary embodiment, the document classification attribute is obtained from the log-in user information. However, in the exemplary embodiment, a corresponding document classification attribute is obtained from an instruction command indicating one of a plurality of document classification attributes.

In step S1302, the integrated document management unit 511 specifies a corresponding real document by using the document classification attribute obtained in step S1301 and designated integrated document ID.

This processing is different from that of step S1003 since it is information obtained in step S1301. Subsequent steps S1004 to S1007 are similar to those shown in FIG. 10.

According to the present exemplary embodiment, the integrated document management system of the first exemplary embodiment can be realized even in a case where there is a plurality of document classification attributes.

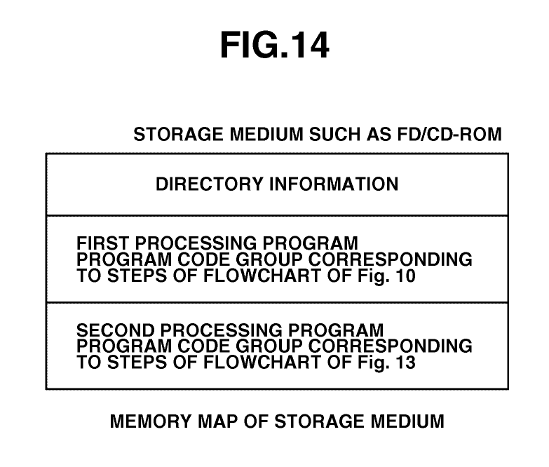

Now, referring to a memory map of FIG. 14, a configuration of a data processing program readable by the document management apparatus according to the exemplary embodiment of the present invention will be described.

FIG. 14 illustrates a memory map of a storage medium for storing various data processing programs readable by the document management apparatus according to the exemplary embodiment of the present invention.

Though not particularly shown, information for managing a program group stored in the storage medium, for example, version information or a creator, and information which depends on OS on a program reading side, such as an icon for identifying and displaying a program may be stored.

Data belonging to various programs are managed in the directory. A program for installing various programs in a computer, or a program for decompressing a compressed installed program may also be stored.

Functions of the exemplary embodiment may be executed by a host computer based on a program installed from the outside. In such a case, the present invention can be applied when an information group including programs is supplied to an output apparatus from a storage medium such as a CD-ROM, a flash memory or a FD, or from an external storage medium via a network.

As described above, the storage medium that records software program codes to realize the functions of the exemplary embodiment is supplied to the system or the apparatus. The object of the present invention can be achieved when the computer (or CPU or MPU) of the system or the apparatus reads the program codes stored in the storage medium to execute them.

In this case, the program codes themselves read from the storage medium realize new functions of the present invention, and the storage medium storing the program codes constitutes the present invention.

Thus, there are no restrictions on a program form as long as the functions or processes of the present invention are realized. For example, the present invention can be applied to an object code, a program executed by an interpreter, or script data supplied to the OS.

For the storage medium to supply programs, for example, a flexible disk, a hard disk, an optical disk, a magneto-optical disk, a MO, a CD-ROM, a CD-R, a CD-RW, a magnetic tape, a nonvolatile memory card, a ROM or a DVD can be used.

In this case, the program codes read from the storage medium realize the functions of the exemplary embodiment themselves, and the computer readable storage medium storing the program codes is within the present invention.

For a program supply method, the browser of the client computer is used to connect to a homepage of the Internet. The program can be supplied by downloading the computer program of the present invention itself or a compressed file including an automatic install function to a recording medium such as a hard disk. The functions can be realized by dividing a program code constituting a program of the present invention into a plurality of files, and downloading the files from different home pages. In other words, a WWW server or an ftp server that causes a plurality of users to download program files to realize functions of the present invention is within claims of the present invention.

The programs of the present invention are encrypted to be stored in a storage medium such as a CD-ROM, and distributed to users, and users who satisfy predetermined conditions are allowed to download key information for decryption from the home page via the Internet. By using the key information, the encrypted programs are executed to be installed in the computer, whereby the functions can be realized.

The program codes read by the computer can be executed to realize the functions of the exemplary embodiment. Furthermore, for example, the operating system (OS) running on the computer carries out all or a part of actual processing based on instructions of the program codes. This processing realizes the functions of the exemplary embodiment. This case is also within the present invention.

The program codes read from the storage medium are written in a memory of a function extension board inserted into a computer or a function extension unit connected to the computer. Then, based on instructions of the program codes, a CPU of the function extension board or the function extension carries out all or a part of actual processing, and the processing realizes the functions of the exemplary embodiment. This case is also within the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-222617 filed Aug. 29, 2008, which is hereby incorporated by reference herein in its entirety.

What is claimed is:

1. A document management apparatus capable of processing a request from a user logged in from an information processing apparatus via a network, comprising:
a user management unit configured to manage attribute information for specifying document information to be used by a user logging in from the information processing apparatus;
a document management unit configured to associate document information having different document attributes obtained from the information processing apparatus with one another to manage the document information as integrated document information;
a determination unit configured to determine whether the document information requested by the log-in user is an integrated document;
a specifying unit configured to specify, when the determination unit determines that the document information requested by the log-in user is an integrated document, document information to be referred to by the user from the integrated document information based on the attribute information of the log-in user; and
a processing unit configured to process a request from the user for the document information specified by the specifying unit.

2. The document management apparatus according to claim 1, wherein the information processing apparatus includes an image forming apparatus and a data processing apparatus configured to communicate with the information processing apparatus via a browser.

3. The document management apparatus according to claim 1, wherein the request from the user is a registration request to register the document information and a presentation request to present the document information to the information processing apparatus.

4. The document management apparatus according to claim 1, wherein the document management unit manages the document information for each version.

5. The document management unit according to claim 1, wherein the document attribute is a document classification attribute for identifying a language of the document information.

6. The document management unit according to claim 1, wherein the user management unit manages a plurality of pieces of attribute information for specifying document information used by the user.

7. The document management unit according to claim 1, wherein the information processing unit further includes a client apparatus and an image forming apparatus.

8. A document management method in a document management apparatus capable of processing a request from a user logged in from an information processing apparatus via a network, comprising:
managing attribute information for specifying document information to be used by a user logging in from the information processing apparatus;
associating document information having different document attributes obtained from the information processing apparatus with one another to manage the document information as integrated document information;
determining whether the document information logged in by the user to be requested is an integrated document;
specifying, when the document information requested by the log-in user is determined to be an integrated document, document information to be referred to by the user from the integrated document information based on the attribute information of the log-in user; and
processing a request from the user for the specified document information.

9. The document management method according to claim 8, wherein the information processing apparatus includes an image forming apparatus and a data processing apparatus configured to communicate with the information processing apparatus via a browser.

10. The document management method according to claim 8, wherein the request from the user is a registration request to register the document information and a presentation request to present the document information to the information processing apparatus.

11. The document management method according to claim 8, wherein the document management manages document information for each version.

12. The document management method according to claim 8, wherein the document attribute is a document classification attribute for identifying a language of the document information.

13. The document management method according to claim 8, wherein the user management manages a plurality of pieces of attribute information for specifying document information used by the user.

14. The document management method according to claim 8, wherein the information processing unit further includes a client apparatus and an image forming apparatus.

15. A program for causing a computer to execute the document management method of claim 8.
